(19) United States
(12) Patent Application Publication
(10) Pub. No.: US 2001/0011844 A1
(43) Pub. Date: Aug. 9, 2001

(54) METHOD AND ARRANGEMENT FOR CONTROLLING FUNCTIONS IN A PROGRAMME- CONTROLLED CIRCUIT IN THE EVENT OF OPERATING VOLTAGE FAILURE

(76) Inventors: EDMUND ERNST, MUNCHEN (DE); JOSEF KLEIN, DIETRAMSZELL (DE); KAI SCHMIDT, VATERSTETTEN (DE)

Correspondence Address: HILL STEADMAN & SIMPSON, 85TH FLOOR SEARS TOWER, CHICAGO, IL, 60606

(21) Appl. No.: 09/269,615

(22) PCT Filed: Sep. 9, 1997
(86) PCT No.: PCT/DE97/02002

§ 371 Date: None

(30) Foreign Application Priority Data
Sep. 26, 1996 (DE) 196 39 644.1

(51) Int. Cl. H02J 9/00

(52) U.S. Cl. 307/64

(57) ABSTRACT

In the method according to the invention, when the operating voltage (BS) supplied by a primary voltage source fails in a program-controlled circuit arrangement (STB), the latter is supplied with supply voltage (VS) by a standby voltage source (EQ) with a limited energy reserve. Depending on the level of the supply voltage (VS), at least one subfunction of the functions realized in the circuit arrangement (STB) is deactivated in dependence on the importance of the said functions and/or the function sequence-specific energy consumption of the said functions, the energy reserve of the standby voltage source (EQ) being optimally utilized taking account of the overall functionality.

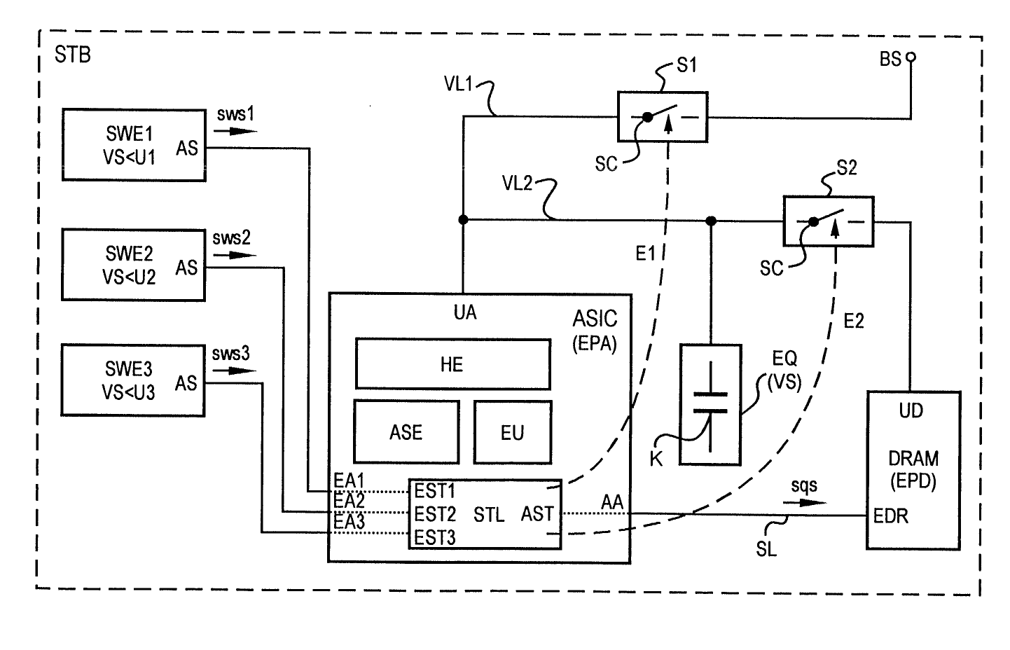

In data processing and switching systems, in particular communications systems, measures may be necessary for ensuring a predeterminable or defined behaviour of the communications system when the operating voltage—primary voltage source—fails. These measures effect, for example, protection of critical data and/or operating states of the communications system during and beyond the period of time for which the voltage failure lasts, and/or ensure the maintenance of high-priority functions—fundamental basic functions—and/or of the facilities realized by the said functions. In addition, important events or program-specific sequence information items of program-controlled processes which are currently active when the voltage fails are recorded—for example the trace or debugging information items necessary for error analysis. Backup batteries or accumulators have been used to date in communications systems or in computer systems for the energy supply that is necessary in order to carry out the measures explained when the operating voltage fails, which batteries or accumulators keep the communications system or the computer system in an operationally available state or enable at least emergency operation. However, this standby energy supply, which is indispensable for specific applications, is associated with high costs. As an alternative, a more cost-effective maintenance of at least part of the functionality of the system when the operating voltage fails can be ensured by a partial energy supply of the communications system, in which case important subfunctions and/or circuit sections of the system are kept in an operationally available state or, at least, data losses are prevented. Such partial energy supplies—or buffering of components of the communications system by a battery or an accumulator—are implemented for example in the case of volatile memory modules recording critical data or in the case of real-time clock circuits. However, buffering subfunctions considerably restricts the functionality of a system when the operating voltage fails.

The invention is based on the object, in the context of operating voltage failures in information technology arrangements, of optimally utilizing the available energy with regard to maintaining the maximum possible functionality of the arrangement. Taking a method and an arrangement according to the features of the preambles of Patent claims 1 and 7 as a departure point, the object is achieved by means of the characterizing features of the said claims.

The essential aspect of the method according to the invention consists in the fact that, depending on the level of the supply voltage, at least one subfunction of the functions is deactivated in dependence on predetermined criteria. The deactivation is advantageously carried out in such a way that the energy reserve of the standby voltage source is optimally utilized taking account of the overall functionality—claim 2.

An essential advantage of the method according to the invention consists in the fact that when there is an operating voltage failure, all of the functions that are realized or are proceeding in a communications system, or the facilities realized by the said functions, are treated in a differentiated manner over time; that is to say that for each function or each facility, a criteria-dependent, function- or facility-specific decision is made as to whether the respective function or the respective facility remains in the active state or can be activated or is deactivated. In the case of the method according to the invention, the behaviour or the functionality when the supply voltage fails can be determined individually for each communications system, by stipulating criteria, and, consequently, the available energy of the standby voltage source can be optimally utilized with regard to maintaining a maximum possible functionality of the system.

The predetermined criteria are advantageously represented by priorities which can be assigned to the functions or to subfunctions thereof—claim 3, the priorities being assigned according to the importance of the respective functions or subfunctions to be buffered and/or according to the sub- or function sequence-specific energy consumption—claim 4. Maximum flexibility with regard to the attainable functionality of a communications system after a voltage failure is achieved by the criteria-dependent assignment of priorities.

The method according to the invention is based on the property of various standby voltage sources that when the residual energy content decreases, the level of the supply voltage of the standby voltage source decreases. The dependence on the level of the supply voltage is advantageously defined by this supply voltage falling below at least one predeterminable threshold voltage value—claim 5. By specifying threshold voltage values, it is possible, for example, to realize a predetermined, step-by-step functional restriction of a communications system in a particularly simple manner in terms of program technology. In this case, when the supply voltage falls below a predetermined threshold voltage value, corresponding measures are executed which are coordinated in such a way that as the energy reserve of the standby voltage source decreases, only those functions having the highest priority, that is to say the greatest importance and/or lowest sub- or function sequence-specific energy consumption, remain active.

The standby voltage source with a limited energy reserve is advantageously realized by a backup battery, a nickel-cadmium accumulator or a capacitor having a very high capacitance—claim 6. The use of a capacitor having a very high capacitance makes it possible to dispense with batteries and accumulators, which are problematic with regard to the environment. Production engineering and logistical advantages are additionally afforded—no receptacles or separate handling necessary—, that is to say the method according to the invention can be realized particularly economically, that is to say cost-effectively.

Further refinements, in particular an arrangement for controlling functions in a program-controlled circuit arrangement when the operating voltage fails, can be found in the further claims.

The method according to the invention for controlling functions in a program-controlled circuit arrangement when the operating voltage fails is explained in more detail below with reference to a block diagram.

The block diagram shows a control assembly STB having a sequence controller ASE, a real-time clock EU and an element HE identifying the hardware operating state of the control assembly STB. The hardware operating state of the control assembly STB is determined for example by information items concerning deviations of the frequency of quartz crystals from the normal frequency, instant of the voltage failure, type of activity prior to the voltage failure, or information items regarding program- or circuit-specific debugging or error analysis—trace and debugging information. The sequence controller ASE, real-time clock EU and the element HE identifying the hardware operating state of the control assembly STB are advantageously realized in an application-specific integrated circuit ASIC. A control unit STL, which is necessary for controlling the method according to the invention, is additionally implemented in this application-specific integrated circuit. Furthermore, a volatile memory DRAM is arranged as the main memory in the control assembly STB, which memory is accessed by all of the program processes currently proceeding in the control assembly STB and, consequently, contains the current data of the running processes or current configuration data. A supply voltage input UA of the application-specific integrated circuit ASIC is connected via a first supply line VL1 and a first switching unit S1 to an operating voltage BS which represents the primary voltage source. Furthermore, the supply voltage input UA is connected via a second supply line VL2 to a capacitor K which is used as standby voltage source EQ and has a very high capacitance—also referred to as “Supercap”—and via a second switching unit S2 to a supply voltage input UD of the volatile memory DRAM. During normal, that is to say fault-free, system operation of the control assembly STB, the switches SC arranged in the two switching units S1, S2 are closed and, consequently, the supply voltage inputs UA, UD and the capacitor K used as standby voltage source EQ are connected to the operating voltage BS, the capacitor K being charged with energy. In the following text, both the operating voltage BS supplied by the primary voltage source and the voltage supplied by the standby voltage source EQ are designated as supply voltage VS. Furthermore, the control assembly STB has three threshold value decision circuits SWE1 . . . 3, an output AS of each threshold value decision circuit SWE1 . . . 3 being connected via a connecting line to an input EA1 . . . 3 of the application-specific integrated circuit ASIC, which simultaneously represents an input EST1 . . . 3 of the control unit STL—indicated by dotted lines. In each threshold value decision circuit SWE1 . . . 3, the current level of the supply voltage VS is permanently compared with a threshold voltage value U1 . . . 3 (U1>U2>U3) which is predetermined individually in each case for each threshold value decision circuit SWE1 . . . 3. If the level of the supply voltage VS falls below one of the predetermined threshold voltage values U1 . . . 3, a corresponding threshold value signal sws1 . . . 3 is generated by the corresponding threshold value decision circuit SWE1 . . . 3 and communicated to the control unit STL.

When the operating voltage BS fails, the following steps are carried out in accordance with the method according to the invention:

If the level of the supply voltage VS falls below the first predetermined threshold voltage value U1—failure of the primary voltage source—, this is signalled by the first threshold value decision circuit SWE1 to the control unit STL, which is implemented in the application-specific integrated circuit ASIC, by generation and communication of a first threshold value signal sws1. The control unit STL is designed in such a way that when the first threshold value signal sws1 is received, all the program processes currently proceeding in the control assembly STB and the processor accesses—for example to the volatile memory DRAM—which are executed by the said processes are concluded in accordance with the process and, consequently, all of the data to be protected during and beyond the failure of the operating voltage BS—in particular the register data, stored in the volatile memory DRAM, of the individual program processes that are active at the instant of the operating voltage failure—are updated and, consequently, represent a stable program state of the control assembly STD. Subsequently, the control unit STL isolates the application-specific integrated circuit ASIC and the volatile memory DRAM from the operating voltage BS—indicated by the opening (illustrated by a dashed arrow E1) of the switch SC arranged in the switching unit S1—, the said units—ASIC, DRAM—being supplied with the supply voltage VS or energy—buffering—by the capacitor K acting as standby voltage source EQ. As a further measure, a special control signal sequence sqs is generated in the control unit STL and passed via an output AST of the control unit STL, which simultaneously represents an output AA of the application-specific integrated circuit ASIC, and via a signalling line SL to an input EDR of the volatile memory DRAM. As a result of receiving the control signal sequence sqs, the volatile memory DRAM is switched to a state in which although write and read accesses are no longer possible, the data stored therein are preserved—“self-refresh mode” and “power-down mode”. As a result of the buffering of the application-specific integrated circuit ASIC and of the volatile memory DRAM, the following information items, which are relevant to reinitialization or reactivation of the control assembly STB or to an error analysis, are protected during and beyond the failure of the operating voltage BS:

the current data in the volatile memory DRAM, for example the last status of the system configuration,

the current time of day—real-time clock continues to run—, and also

the hardware operating state identified by the element HE—this should be emphasized insofar as current hardware information items cannot be stored in the volatile memory DRAM and, consequently, cannot be protected by solely buffering the volatile memory DRAM.

If the level of the supply voltage VS supplied by the standby voltage source EQ falls below a predetermined second threshold voltage value U2, this is signalled by the second threshold value decision circuit SWE2 to the control unit STL by generation and communication of a second threshold value signal sws2, which control unit, upon receiving the second threshold value signal sws2, deactivates the buffering of the volatile memory DRAM, that is to say isolates the supply voltage input UD of the volatile memory DRAM from the standby voltage source EQ—indicated by the opening (illustrated by a dashed arrow E2) of the switch SC arranged in the switching unit S2. The data stored in the volatile memory DRAM are lost in the process. The two threshold voltage values U1, U2 are advantageously defined in such a way that, in the present application of the control assembly STB, the period of time from the failure of the primary voltage source—BS or VS<U1—until the supply voltage VS supplied by the standby voltage source EQ falls below the second threshold voltage value U2—VS<U2—is sufficient for a proper read-out of the data stored in the volatile memory DRAM and, consequently, the control assembly STB, or a communications systems integrating the control assembly STL, can continue to be operated in the normal mode after reactivation of the primary voltage source or operating voltage BS, without any loss of data. Since the buffering of the volatile memory DRAM which is switched to the “power-down mode” signifies a considerable power or energy consumption EPD which is relevant to the criteria-dependent decision process according to the invention, it is possible, as a result of the disconnection of the volatile memory DRAM from the standby voltage source EQ, to achieve a significantly longer buffering time for the remaining high-priority, dynamic functions proceeding in the application-specific integrated circuit ASIC. By means of these dynamic functions, for example, the withdrawal of the control assembly STB from a mounting rack is identified and a corresponding data record provided with the current time of day is stored in the application-specific integrated circuit ASIC.

If the level of the supply voltage VS supplied by the standby voltage source EQ falls below the predetermined third threshold voltage value U3—VS<U3—, this is signalled by the third threshold value decision circuit SWE3 to the control unit STL by generation and communication of a third threshold value signal sws3. Upon receiving the third threshold value signal sws3, the control unit STL causes the deactivation of all dynamic, high-priority functions still proceeding in the application-specific integrated circuit ASIC. As a result, the energy requirement EPA of the application-specific integrated circuit ASIC is considerably reduced even further, since the integrated circuit ASIC, realized using CMOS technology, has a very low power consumption or energy consumption in the static mode. In this state, the information items identifying the hardware operating state continue to be recorded and are available for continuing evaluations—for example sequence and error analysis—after restarting of the control assembly, that is to say reestablishment of the primary voltage source.

A predetermined, system-specific behaviour of the control assembly STB when the primary voltage source fails can be realized with very little outlay by means of the method according to the invention, described in this exemplary embodiment, for implementing measures which are arranged at a plurality of levels—power-down hierarchy—, that is to say are coordinated with the respective current level of supply voltage VS. By introducing further levels—for example by introducing further threshold voltage values U4 . . . n—and using threshold voltage value decision circuits SW4 . . . n which are programmable and can thus be adapted to the current operating case, it is advantageously possible to define the functionality of a system more precisely during an operating voltage failure and to adapt it to the respective application.

1. Method for controlling functions in a program-controlled circuit arrangement (STB) when the operating voltage (BS) fails, in which case, when the operating voltage (BS) fails, the circuit arrangement (STB) is supplied with supply voltage (VS) by a standby voltage source (EQ) with a limited energy reserve, which supply voltage (VS) decreases as the energy reserve decreases, characterized
in that, depending on the level of the supply voltage (VS), at least one subfunction of the functions is deactivated in dependence on predetermined criteria (EPD, EPA).

2. Method according to claim 1, characterized
in that the energy reserve of the standby voltage source (EQ) is optimally utilized taking account of the overall functionality.

3. Method according to claim 1 or 2, characterized
in that the predetermined criteria (EPD, EPA) are represented by priorities which can be assigned to the functions or to subfunctions thereof.

4. Method according to claim 3, characterized
in that the priorities are assigned according to
the importance of the respective function or subfunction and/or
the sub- or function sequence-specific energy consumption.

5. Method according to one of the preceding claims, characterized
in that the dependence on the level of the supply voltage (VS) is defined by this supply voltage (VS) falling below at least one predeterminable threshold voltage value (U1 . . . 3).

6. Method according to one of the preceding claims, characterized
in that the standby voltage source (EQ) with a limited energy reserve is realized by
a backup battery or
a nickel-cadmium accumulator or
a capacitor (K) having a very high capacitance.

7. Arrangement for controlling functions in a program-controlled circuit arrangement (STB) when the operating voltage (BS) fails, in which case, when the operating voltage (BS) fails, the circuit arrangement (STB) is supplied with supply voltage (VS) by a standby voltage source (EQ) with a limited energy reserve, which supply voltage (VS) decreases as the energy reserve decreases, characterized
in that, there are arranged in at least one comparator unit (SWE1 . . . 3) means
for acquiring the current level of the supply voltage (VS) and
for forming a threshold value signal (sws1 . . . 3) in dependence on the acquired level of the supply voltage (VS), the threshold value signal (sws1 . . . 3) formed being passed to an output (AS) of the comparator unit (SWE1 . . . 3), and
in that the output (AS) of the at least one comparator unit (SWE1 . . . 3) is in each case connected to an input (EST1 . . . 3) of a control unit (STL), and
in that the control unit (STL) has means for deactivating at least one subfunction of the functions in dependence on the at least one threshold value signal (sws1 . . . 3) respectively present at an input (EST1 . . . 3) and in dependence on predetermined criteria (EPD, EPA).

8. Arrangement according to claim 7, characterized
in that the means for forming a threshold value signal (sws1 . . . 3) are configured in such a way that the threshold value signal (sws1 . . . 3) is formed in dependence on the level of the supply voltage (VS) falling below a predeterminable threshold voltage value (U1 . . . 3).

9. Arrangement according to claim 7 or 8, characterized
in that the means for deactivating at least one subfunction of the functions according to predetermined criteria (EPD, EPA) are configured in such a way that the deactivation of the functions or of subfunctions thereof is effected in dependence on priorities which can be assigned to the functions or to subfunctions thereof, the priorities being assigned according to
the importance of the respective function or subfunction and/or
the sub- or function sequence-specific energy consumption.

10. Arrangement according to claim 7, 8 or 9, characterized
in that the program-controlled circuit arrangement (STB) is integrated in a communications system.
